(19) United States
(12) Patent Application Publication
(10) Pub. No.: US 2003/0123518 A1
(43) Pub. Date: Jul. 3, 2003

(54) Dual wavelength thermal imaging system for surface temperature monitoring and process control

(76) Inventors: Hamid A. Abbasi, Naperville, IL (US); Ishwar K. Puri, Willowbrook, IL (US); David M. Rue, Chicago, IL (US)

Correspondence Address: Mark E. Fejer, Gas Technology Institute, 1700 South Mount Prospect Road, Des Plaines, IL, 60018, US

(21) Appl. No.: 10/038,945

(22) Filed: Jan. 3, 2002

(51) Int. Cl. G01J 5/02

(52) U.S. Cl. 374/124; 374/127

(57) ABSTRACT

A method for high temperature process control in which the surface emission intensity of a surface is measured at two near-infrared wavelengths over an array of points covering a fill field of view. The emissivity variable is removed from the temperature calculation and the surface emission intensity measurements are digitally processed, resulting in generation of a color temperature map. The color temperature map is processed in a thermal imaging control algorithm process, producing control output signals, which are then input to a temperature control means for controlling the surface temperature. The apparatus used in carrying out this method is surface temperature monitoring system which includes a multiple-wavelength, near-infrared thermal imaging system.

### BACKGROUND OF THE INVENTION

1. Field of the Invention

This invention relates to a method and apparatus for temperature monitoring in high temperature furnaces and combustors for the purpose of process optimization and control. More particularly, this invention relates to a method and apparatus for measuring surface temperatures of the interior surfaces of high temperature furnaces and combustors as well as workpieces disposed therein. In addition to measuring surface temperatures, the method and apparatus of this invention can utilize the surface temperature measurements for process optimization and control, including increasing thermal efficiency, lowering NOₓ emissions, eliminating hotspots and handling instabilities that arise.

2. Description of Related Art

Several methods are utilized for temperature monitoring in industrial high temperature furnaces and combustors. One such method employs high temperature thermocouples or water-cooled probes installed to monitor temperature in combustion installations. This method is relatively simple and has been used industrially for decades. However, thermocouples can provide only discrete information on the temperature distribution on the surfaces of a combustion apparatus. In addition, high temperature thermocouples and other direct temperature measuring devices are expensive and generally are not durable. These shortcomings significantly limit the benefits of utilizing these devices for process control purposes.

Another method for monitoring temperatures in industrial high temperature furnaces and combustors utilizes a one wavelength thermal imaging system. One wavelength thermal imaging systems are capable of non-contact field temperature measurements of combustion surfaces. However, this technology relies upon surface emissivity input, a serious disadvantage. The surface emissivity of the hot surfaces depends on the surface properties, optical system positioning relative to the measured surfaces and temperature of the surfaces. Thus, it will be apparent to those skilled in the art that it is not realistic to provide an accurate input of emissivity values for changing parameters of the combustion installation utilizing a one wavelength thermal imaging control system.

Yet a further method for monitoring temperatures in industrial high temperature furnaces and combustors utilizes two-wavelength pyrometers which are capable of discrete measurement of surface temperature with no need to impute surface emissivity. These pyrometers are well-suited for an occasional temperature check or constant manual monitoring of any discrete point of interest. They can also be used as a component of a computerized temperature monitoring and process control system. However, they are of limited use by virtue of their being limited to discrete points on a surface.

Currently used discrete temperature measurements do not provide an entire temperature distribution map of the surfaces in combustion apparatuses. Other thermal imaging systems using one wavelength require emissivity data, are not as accurate or reliable, and require calibration. High temperature thermocouples require maintenance and replacement, and they only make point temperature measurements. Thermocouples and other contact thermometers cannot measure the temperature of surfaces directly in contact with high temperature combustion gases or flames.

### SUMMARY OF THE INVENTION

Accordingly, it is one object of this invention to provide a method and apparatus for monitoring surface temperatures in high temperature industrial furnaces and combustors without physical contact with the surface being monitored.

It is one object of this invention to provide a method and apparatus for monitoring surface temperatures in high temperature industrial furnaces and combustors which does not require the use of surface emissivities for determining the surface temperature.

It is another object of this invention to provide a method and apparatus for monitoring surface temperatures in high temperature industrial furnaces and combustors in which the accuracy is not affected by hot gases or non-sooty flames.

It is yet another object of this invention to provide an apparatus for monitoring surface temperatures in high temperature industrial furnaces and combustors which is able to operate reliably and continuously for extended periods of time in harsh industrial environments.

It is yet a further object of this invention to provide an apparatus for monitoring surface temperatures in high temperature industrial furnaces and combustors which is suitable for use in combustion process control.

These and other objects of this invention are addressed by a surface temperature monitoring system comprising a multiple-wavelength, near-infrared thermal imaging system. In accordance with one preferred embodiment of this invention the multiple-wavelength, near-infrared thermal imaging system is a dual-wavelength, near-infrared thermal imaging system and comprises at least one lens, at least two near-infrared wavelength filters and a CCD sensor or CCD camera.

The method for high temperature process control in accordance with this invention comprises the steps of measuring the surface emission intensity of a surface being monitored at two near-infrared wavelengths over an array of points covering a full field of view, eliminating the emissivity variable from the temperature calculation, digitally processing the surface emission intensity measurements resulting in generation of a color temperature map, processing the color temperature map in a thermal imaging control algorithm process, producing control output signals, and inputting the control output signals to a temperature control means for controlling the surface temperature.

### BRIEF DESCRIPTION OF THE DRAWINGS

These and other objects and features of this invention will be better understood from the following detailed description taken in conjunction with the drawings wherein:

FIG. 1 is a schematic diagram of a monochromator and CCD camera-based furnace imaging system in accordance with one embodiment of this invention; and

FIG. 2 is a schematic diagram of a near-infrared thermal imaging control system in accordance with one embodiment of this invention.

### DETAILED DESCRIPTION OF THE PRESENTLY PREFERRED EMBODIMENTS

The invention disclosed herein is a multiple-wavelength, near-infrared thermal imaging system for surface temperature monitoring and process control. The invention can be utilized for non-contact surface temperature measurement in various high temperature furnaces and combustors. The control process relies on actual field temperature measurements load and refractory temperatures. The thermal imaging system measures the intensity of emissions at two or more near-infrared wavelengths and uses this information to calculate the temperatures of entire surfaces. Utilization of this multiple-wavelength technique eliminates the need to input emissivity values of the measured surfaces into the temperature calculation algorithm. The invention may provide significant improvements in combustion control technology because non-contact field temperature measurements can provide significantly more accurate, reliable and complete field temperature measurements. In addition, a much wider range of temperatures can be measured than using other techniques while also measuring temperatures of multiple compositions and at angles to the plane of the detector. Furthermore, the real-time field temperature data produced by the method and apparatus of this invention is reliable enough to be used directly in online furnace control.

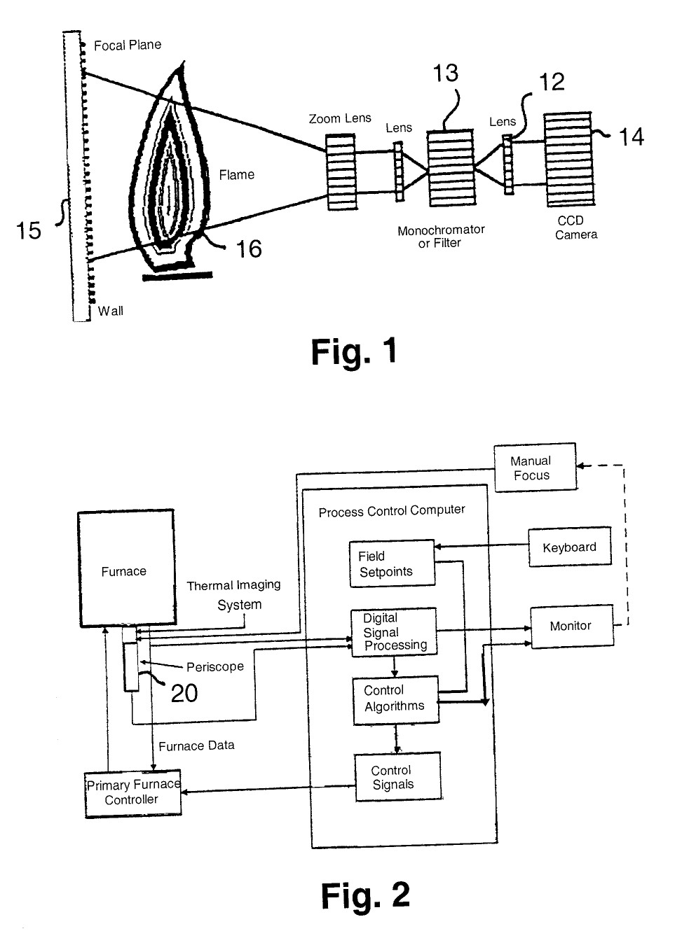

The thermal imaging system in accordance with one embodiment of this invention, as shown in FIG. 1, comprises at least one lens 12, at least one near-infrared filter 13, and a CCD sensor/camera 14. The lens, filter(s) and CCD sensor/camera are mounted on a water-cooled periscope 20 as shown in FIG. 2. Periscope 20, as shown in FIG. 2, may be mounted in a furnace, thereby enabling viewing of the entire field of combustion space. The system can collect field temperature signals on the complete furnace with or without physical movement of the imaging system or the periscope. Field temperature measurements are made by evaluating emission intensities at two distinct wavelength bands, for example 750 and 800 nm or other dual wavelengths bands in the near infrared range. These wavelengths are selected to provide a clear view, undistorted by visible light and by glowing combustion gases that radiate frequencies above 1000 nm. Any sensitive CCD camera can be used to measure light intensity at the wavelengths of interest. Light filtering can be performed using an imaging monochromator, a tunable liquid crystal filter or glass filters.

Emitted light intensity maps at each of the two chosen wavelength bands are displayed and recorded using a standard personal computer and a frame grabber or some other video hardware. The collected light emission information is digitally processed; surface temperature distribution is calculated, recorded and displayed as a color temperature map. The thermal imaging control system can be programmed to maintain a desired temperature distribution on high temperature surfaces of interest. This task may be accomplished by inputting a target temperature map into a special input interface of the thermal imaging control system. The thermal imaging control system routinely compares the target temperature map with the actual temperature readings and generates the necessary signal information for transmission to the combustion (or other) control system.

In the conceptualized thermal imaging system shown in FIG. 1, filtered infrared signals are sent to a CCD camera for comprehensive thermal imaging of the walls 15, load and flames 16 of a furnace. The full field is covered with a false color temperature map. Resolutions of 0.5 to 1.0 million pixels is preferred with the time delay from the thermal imaging system increasing with higher resolutions. The signal is sent to a beam splitter from which one beam is sent to a monitor for manual focusing while the other beam is sent to a process control computer for digital signal processing. The digitally processed signal is sent to a set of control algorithms along with the set point furnace field temperature mapping information. The control algorithms then generate control signals that are sent to the primary furnace controller. These control signals are combined with the primary furnace control signals to provide finer control of the furnace.

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of this invention.

We claim:

1. A surface temperature monitoring system comprising:
a multiple-wavelength, near-infrared thermal imaging system.

2. A system in accordance with claim 1, wherein said multiple-wavelength, near-infrared thermal imaging system is a dual-wavelength, near-infrared thermal imaging system.

3. A system in accordance with claim 1, wherein said multiple-wavelength, near-infrared thermal imaging system comprises at least one lens, at least two near-infrared wavelength filters and one of a CCD sensor and a CCD camera.

4. A system in accordance with claim 3, wherein said at least one lens, said at least two near-infrared wavelength filters and said one of said CCD sensor and said CCD camera are mounted on a water-cooled periscope adapted for mounting in a furnace.

5. A system in accordance with claim 3, wherein said at least two near-infrared wavelength filters are selected from the group consisting of an imaging monochromator, a tunable liquid crystal filter, glass filters and a combination thereof.

6. A system in accordance with claim 3, wherein said at least two near-infrared wavelength filters are adapted to filter out wavelengths at frequencies above about 1100 nm.

7. A system in accordance with claim 4, wherein said one of said CCD sensor and said CCD camera comprises a signal output operably connected to a digital signal processing means.

8. A system in accordance with claim 7, wherein said digital signal processing means is operably connected to control means for controlling a surface temperature.

9. A system in accordance with claim 1, wherein said multiple-wavelength, near-infrared thermal imaging system is adapted to monitor surface temperatures in a range of about 200° C. to about 2000° C.

10. A system in accordance with claim 8, wherein said digital signal processing means comprises at least one system algorithm adapted to determine said surface temperature without employing surface emissivities.

11. A system in accordance with claim 10, wherein said at least one system algorithm comprises a multiple wave field temperature measurement algorithm.

12. A method for high temperature process control comprising the steps of:
measuring a surface emission intensity of a surface at two near-infrared wavelengths over an array of points covering a full field of view;
removing an emissivity variable from a temperature calculation;
digitally processing said surface emission intensity measurements, resulting in generation of a color temperature map;
processing said color temperature map in a thermal imaging control algorithm process, producing control output signals; and
inputting said control output signals to a temperature control means for controlling said surface temperature.

13. A method in accordance with claim 12, wherein said surface emission intensity is measured using a multiple-wavelength, near-infrared thermal imaging system.

14. A method in accordance with claim 13, wherein said multiple-wavelength, near-infrared thermal imaging system measures surface temperatures in a range of about 200° C. to about 2000° C.

15. A method in accordance with claim 12, wherein a feedback control is used to operate the thermal imaging control algorithm process from one reading to a next reading.

16. A method in accordance with claim 12, wherein said two near-infrared wavelengths are less than about 1100 nm.

17. A method in accordance with claim 12, wherein said two near-infrared wavelengths are in a range of about 600 nm to about 1100 nm.

18. A method in accordance with claim 12, wherein said two near-infrared wavelengths are in a range of about 700 nm to about 900 nm.

19. An apparatus comprising:
means for monitoring surface temperature comprising a multiple-wavelength, near-infrared thermal imaging system.

20. An apparatus in accordance with claim 19, wherein said multiple-wavelength, near-infrared thermal imaging system is a dual-wavelength, near-infrared thermal imaging system.

21. An apparatus in accordance with claim 19, wherein said multiple-wavelength, near-infrared thermal imaging system comprises at least one lens, at least two near-infrared wavelength filters and one of a CCD sensor and a CCD camera.

22. An apparatus in accordance with claim 21, wherein said at least one lens, said at least two near-infrared wavelength filters and said one of said CCD sensor and said CCD camera are mounted on a water-cooled periscope adapted for mounting in a furnace.

23. An apparatus in accordance with claim 21, wherein said at least two near-infrared wavelength filters are selected from the group consisting of an imaging monochromator, a tunable liquid crystal filter, glass filters and a combination thereof.

24. An apparatus in accordance with claim 21, wherein said at least two near-infrared wavelength filters are adapted to filter out wavelengths at frequencies above about 1100 nm.

25. An apparatus in accordance with claim 22, wherein said one of said CCD sensor and said CCD camera comprises a signal output operably connected to a digital signal processing means.

26. An apparatus in accordance with claim 22, wherein said digital signal processing means is operably connected to control means for controlling a surface temperature.

27. An apparatus in accordance with claim 19, wherein said multiple-wavelength, near-infrared thermal imaging system is adapted to monitor surface temperatures in a range of about 200° C. to about 2000° C.

28. An apparatus in accordance with claim 23, wherein said digital signal processing means comprises at least one system algorithm adapted to determine said surface temperature without employing surface emissivities.

29. An apparatus in accordance with claim 28, wherein said at least one system algorithm comprises a multiple wave field temperature measurement algorithm.
